(19) United States
(12) Patent Application Publication
(10) Pub. No.: US 2024/0416690 A1
(43) Pub. Date: Dec. 19, 2024

(54) SENSOR DATA RETRIEVAL FROM RADIO FREQUENCY IDENTIFICATION (RFID) DEVICE

(71) Applicant: The Goodyear Tire & Rubber Company, Akron, OH (US)

(72) Inventor: Stephan Rodewald, Dubuque, IA (US)

(21) Appl. No.: 18/642,904

(22) Filed: Apr. 23, 2024

Related U.S. Application Data
(60) Provisional application No. 63/508,002, filed on Jun. 14, 2023.

(51) Int. Cl. B60C 23/04; G06K 19/07; G06K 19/077

(52) U.S. Cl. CPC B60C 23/0452; G06K 19/0723; G06K 19/07764

(57) ABSTRACT

The present disclosure relates to programming tire sensors mounted to a tire of a vehicle. An identification tag device (e.g., radio frequency identification (RFID) tag) stores tire information data and/or other data that is unique to a given tire. The identification tag device can be attached to or otherwise contained within a tire-integrated sensor mount configured to support a sensor. The identification tag device transmits tire identification data and/or other data stored by the identification tag device to a sensor when the sensor is attached to or otherwise supported by the tire-integrated sensor mount. The sensor can obtain the tire identification data associated with the tire on which the sensor is mounted, thereby allowing the sensor to associate collected sensor data (e.g., pressure, temperature, etc.) with the tire identification data that is unique to the tire.

### BACKGROUND

Vehicles can be equipped with tire sensors mounted on a tire for each wheel on the vehicle to obtain information regarding physical parameters of the tire, such as, for example, tire pressure, temperature, and the like. The information obtained from the sensors can be used to detect potential issues with the tires that may result in unsafe driving conditions. For example, data obtained from a tire sensor may be used to detect an underinflated tire. Upon detection, the user of the vehicle can be notified of the underinflated tire through an indicator light in the dashboard of the vehicle. In various examples, the data obtained from the tire sensor may be associated with tire identification data and/or other information that is specific to a given tire.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a vehicle with one or more tires that a sensor according to various embodiments of the present disclosure.

FIGS. 2 and 3 are perspective cross-sectional views of a tire shown in FIG. 1, where a sensor mount assembly is mounted on the inside of the tire 103 according to various embodiments of the present disclosure.

FIG. 4 is an example of a networked environment including a sensor and tire identification (ID) tag that are in communication with each other according to various embodiments of the present disclosure.

FIG. 5 is a sequence diagram illustrating an example of functionality in the network environment of FIG. 4 according to various embodiments of the present disclosure.

### DEFINITIONS

“Innerliner” means the layer or layers of elastomer or other material that form the inside surface of a tubeless tire and that contain the inflating gas within the tire.

“TPMS” means a tire pressure monitoring system, which is an electronic system that measures the internal pressure of a tire and is capable of communicating the pressure to a processor that is mounted on the vehicle and/or is in electronic communication with electronic systems of the vehicle.

### DETAILED DESCRIPTION

The present disclosure relates to programming tire sensors according to various embodiments. Tire sensors can be programed with tire identification data, which can be unique to the tire in which the tire sensor is attached. However, if a tire sensor becomes defective during the service life of the tire, a replacement sensor may be required. Traditionally, a tire sensor is externally programmed with the unique tire identification data and/or other pertinent data before entering service. Externally programing a replacement sensor is an inherently manual, error prone process, which can raise data integrity and safety concerns. Therefore, it would be beneficial to be able to automatically program a sensor with the tire identification data and/or other pertinent data.

In various examples, an identification tag device (e.g., radio frequency identification (RFID) tag) stores tire information data and/or other data that is unique to a given tire. In various examples, the identification tag device can be attached to or otherwise contained within a tire-integrated sensor mount configured to support a sensor. In various examples, the identification tag device is configured to transmit tire identification data and/or other data stored by the identification tag device to a sensor when the sensor is attached to or otherwise supported by the tire-integrated sensor mount. Accordingly, the sensor can obtain the tire identification data associated with the tire on which the sensor is mounted, thereby allowing the sensor to associate collected sensor data (e.g., pressure, temperature, etc.) with the tire identification data that is unique to the tire. It should be noted that although the discussion of the disclosure relates to pneumatic tires, the disclosure is not limited to pneumatic tires and can apply to all types of tires, including pneumatic and non-pneumatic tires.

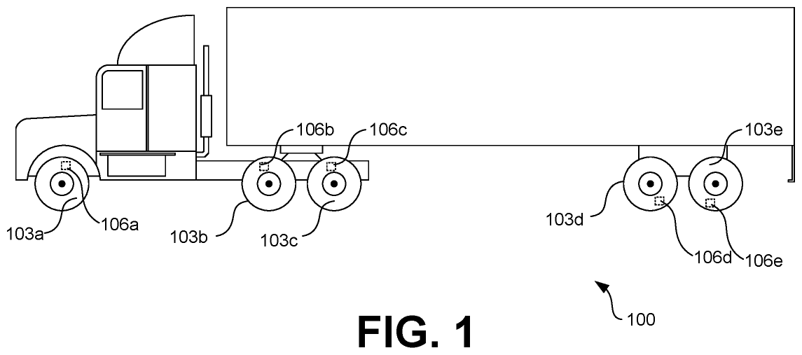

With reference to FIG. 1, a vehicle 100 is shown with one or more tires 103 (e.g., 103a, 103b, 103c, 103d, 103e). Although illustrated and described as pneumatic tires, it is noted that the tires 103 are not limited to pneumatic tires and can apply to all types of tires, including pneumatic and non-pneumatic tires Each tire 103 includes a sensor 106 (e.g., 106a, 106b, 106c, 106d, 106e). In various examples, the sensor 106 is mounted on each tire 103 for the purpose of detecting certain real-time parameters of the tire 103, such as tire pressure and tire temperature. In various examples, the sensor 106 can comprise at least one of a pressure sensor to sense the inflation pressure within a cavity of the tire, a temperature sensor to measure a temperature of the tire, an accelerometer for measuring acceleration of a wheel on which the tire 103 is mounted, a revolution counter to measure a revolution time of the wheel, and/or other types of sensors.

In some embodiments, the sensor 106 is a component of or comprises a tire pressure monitoring system (TPMS) module or sensing unit. In some aspects, each one of the tires 103 on the vehicle 100 includes one or more of the sensors 106. While the vehicle 100 is depicted as a commercial truck, the vehicle 100 may comprise any type of vehicle that employs tires where the commercial truck is presented as an example. To this end, the vehicle 100 may comprise other vehicles falling into various categories such as passenger vehicles, off-road vehicles, and the like, in which such vehicles include a greater or lesser number of tires 103 than are shown in FIG. 1.

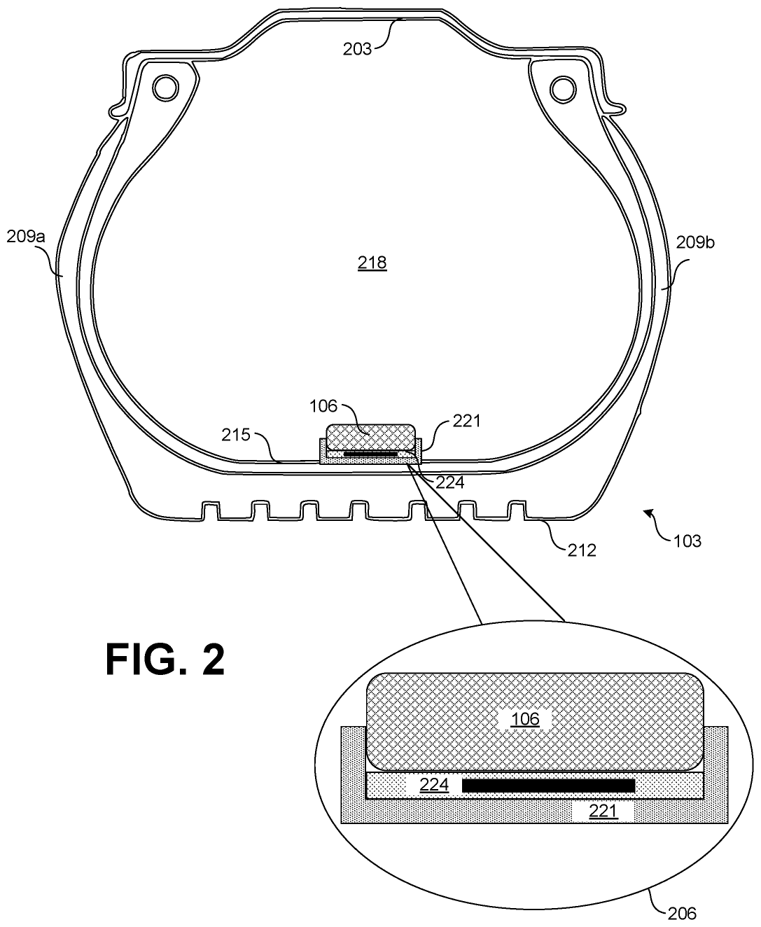

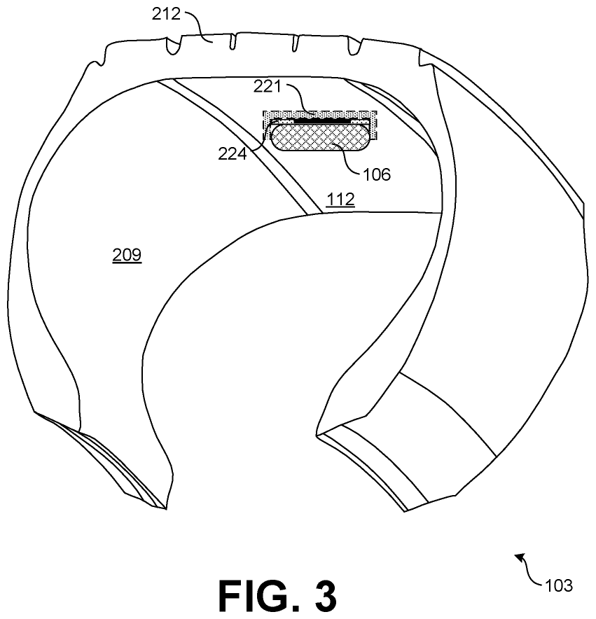

Turning now to FIGS. 2 and 3, shown are cross-sectional views of a tire 103, where a sensor mount assembly is mounted on the inside of the tire 103. In particular, FIG. 2 illustrates a cross-sectional view of a tire 103 on a wheel 203, where a sensor mount assembly 206 is mounted on the inside of the tire 103. FIG. 3 illustrates a cross-sectional view of a tire 103 without the wheel 203, where a sensor mount assembly 206 is mounted on the inside of the tire 103. The tires 103 are of conventional construction, and each tire is mounted on a respective wheel 203 as known to those skilled in the art. Each tire 103 includes a pair of sidewalls 209 (e.g., 209a, 209b) that extend to a circumferential tread 212. An innerliner 215 is disposed on the inner surface of the tire 103, and when the tire is mounted on the wheel 203, an internal cavity 218 is formed, which is filled with a pressurized medium, such as air.

In various examples, the sensor mount assembly 206 comprises a sensor mount 221, a tire identification (ID) tag 224, and a sensor 106. In some examples, the sensor 106 can be detachably attached from the sensor mount 221. For example, if a sensor 106 becomes defective during a service life (e.g., life of a tire 103), the sensor 106 may need to be replaced. As such, the sensor 106 can be detached or otherwise removed from the sensor mount 221 to allow for the placement of a replacement sensor 106. Accordingly, in some examples, the sensor mount assembly 206 can comprise the sensor mount 221 and the tire ID tag 224 without the sensor 106.

As shown in FIG. 2, the sensor mount assembly 206 comprises the tire ID tag 224 affixed to or otherwise integrated or contained within the sensor mount 221. In various examples, the sensor 106 can be attached to or mounted on the sensor mount 221 such that the sensor 106 engages with or abuts an inner surface of the sensor mount 221. In some examples, the sensor 106 is mechanically mounted to the sensor mount 221. In other examples, the sensor 106 is attached to the sensor mount 221 via an adhesive or other suitable form of attachment. It should be noted that the positioning of the tire ID tag 224 and the sensor 106 within the sensor mount assembly 206 are such that the sensor 106 can communicate with the tire ID tag 224 in accordance with the embodiments of the disclosure.

The sensor mount 221 is designed and configured to support a sensor 106 that detects certain real-time parameters of the tire 103, such as tire pressure and tire temperature. It should be noted that the size and shape of the sensor mount 221 is not limited to the size and shape of the sensor mount 221 of FIG. 2 and can be of any suitable size and shape such that a sensor 106 can be attached to and supported by the sensor mount 221. In various examples, the sensor mount 221 is attached to or integrated within the innerliner 215 and/or other components of the tire 103. For example, the sensor mount 221 can be attached to the tire 103 via an adhesive or other suitable type of attachment means. In other examples, the sensor mount 221 is integrated within one or more components of the tire 103. In some examples, the sensor mount 221 can be molded into the one or more components of the tire 103 during the manufacturing of the tire. In some examples, the sensor mount 221 can be formed from a material that is similar to and/or the same of that of the innerliner 215 and/or other tire components. In other examples, the sensor mount can be formed from plastic and/or other suitable types of materials so long as the sensor mount 221 can support the sensor 106 during the operation of the tire 103.

In various examples, the tire ID tag 224 comprises a conventional radio frequency identification (RFID) tag device. In some examples, the tire ID tag 224 is in a dipole configuration although other tag configurations may be employed if so desired. The tire ID tag 224 is of a general type including a substrate supporting an IC (integrated circuit) package and having conductive coiled antenna arms. Such a tag is shown and described in U.S. Pat. No. 8,441,355 hereby incorporated herein in its entirety by reference.

In various examples, the tire ID tag 224 can store tire information that is unique to the tire 103 on which the tire ID tag 224 is mounted. The tire information can include a tire identifier (ID), manufacturing information for the tire 103 (e.g., model number, manufacturer name, etc.), size information (e.g., rim size, width, and outer diameter), manufacturing location, manufacturing date, a treadcap code that includes or correlates to a compound identification, a mold code that includes or correlates to a tread structure identification, and/or other information. The vehicle tire information may also include a service history or other information to identify specific features and parameters of each tire 103. In various examples, the tire ID tag 224 is operable to wirelessly transmit the tire identification data to the sensor 106 and/or other remote receiver.

In various examples, the sensor 106 is mounted on a tire 103 for the purpose of detecting certain real-time parameters of the tire 103, such as tire pressure and tire temperature. In various examples, the sensor 106 can comprise at least one of a pressure sensor to sense the inflation pressure within a cavity of the tire, a temperature sensor to measure a temperature of the tire, an accelerometer for measuring acceleration of a wheel on which the tire 103 is mounted, a revolution counter to measure a revolution time of the wheel, and/or other types of sensors.

In various examples, the sensor 106 comprises a processor and memory to store vehicle tire information for each specific tire 103. For example, the tire vehicle tire information can include a tire identifier (ID), manufacturing information for the tire 103 (e.g., model number, manufacturer name, etc.), size information (e.g., rim size, width, and outer diameter), manufacturing location, manufacturing date, a treadcap code that includes or correlates to a compound identification, a mold code that includes or correlates to a tread structure identification, and/or other information. The vehicle tire information may also include a service history or other information to identify specific features and parameters of each tire 103. In various examples, the sensor 106 is configured to wirelessly communicate with the tire ID tag 224 to receive the tire identification data from the tire ID tag 224.

The sensor 106 further includes an antenna for wirelessly transmitting measured parameters and tire information data to a remote processor for analysis, such as a processor integrated into a vehicle computing device, a Controller Area Network (CAN) bus associated with the vehicle 100, and/or a cloud computing device. According to various embodiments, each one of the tires 103 on the vehicle 100 may include one or more of the sensors 106.

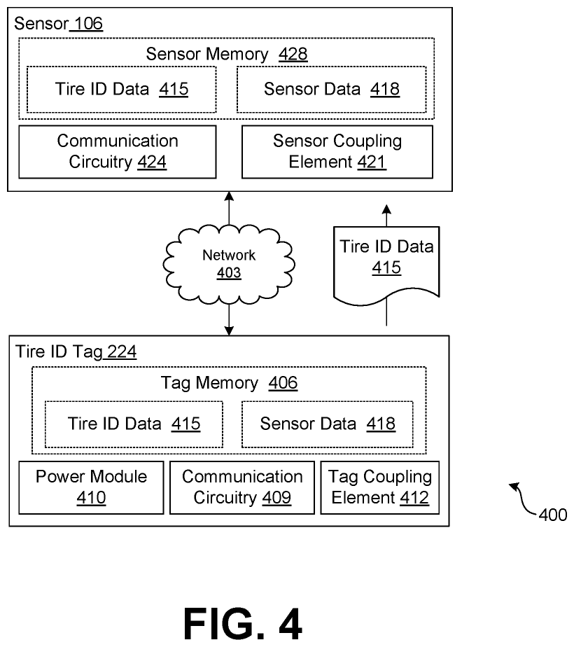

Turning now to FIG. 4, shown is a networked environment 400 according to various embodiments. The networked environment 400 includes a sensor 106 and a tire ID tag 224 which are in data communication with each other via a network 403. In various examples, the network 403 can include a local area network (LAN) and can include wired or wireless components or a combination thereof. Wireless networks can include Institute of Electrical and Electronic Engineers (IEEE) 802.11 wireless networks (i.e., WI-FI®), BLUETOOTH® networks, radio transmission networks, microwave transmission networks, as well as other networks relying on radio broadcasts. The network 403 can also include a combination of two or more networks 403.

In various examples, the tire ID tag 224 comprises a conventional radio frequency identification (RFID) tag device. For example, the tire ID tag 224 can comprise a memory 406, communication circuitry 409 (e.g., transmitter, receiver, transceiver, etc.), a power module 410, and a coupling element 412 (e.g., antenna or coil).

The memory 406 can comprise tire ID data 415, sensor data 418, and/or other data. The tire ID data 415 can include a tire identifier (ID), manufacturing information for the tire 103 (e.g., model number, manufacturer name, etc.), size information (e.g., rim size, width, and outer diameter), manufacturing location, manufacturing date, a treadcap code that includes or correlates to a compound identification, a mold code that includes or correlates to a tread structure identification, and/or other information. The vehicle tire information may also include a service history or other information to identify specific features and parameters of each tire 103.

The sensor data 418 can include information collected by the sensor 106. For example, the sensor 106 can collect real-time parameters of the tire 103, such as tire pressure, tire temperature, acceleration, revolutions, and/or other parameter associated with the tire. In various examples, the sensor 106 can comprise at least one of a pressure sensor to sense the inflation pressure within a cavity of the tire, a temperature sensor to measure a temperature of the tire, an accelerometer for measuring acceleration of a wheel on which the tire 103 is mounted, a revolution counter to measure a revolution time of the wheel, and/or other types of sensors.

In various examples, the sensor data 418 can include data that has been collected by a sensor 106 that is no longer in communication with the tire ID tag 224. For example, if a sensor 106 becomes defective during a life service of a given tire 103, the sensor 106 can be replaced with a replacement sensor 106. In some examples, the sensor data 418 stored in the tire ID tag 224 can correspond to events or collected data associated with the prior sensor 106 prior to its malfunction and can be transmitted to the replacement sensor 106 or other remote receiver, as can be appreciated.

In the example of an RFID tag, the memory 406 and communication circuitry 409 can be implemented on an RFID chip. In various examples, a portion of the tire ID tag 224 (e.g., RFID chip) comprising the communication circuitry 409 and/or memory 406 can be contacted to the coupling element 412 or it may have an on-chip coil, which can be inductively coupled to yet another coil, to one or more antennas tuned to an operating RF-frequency or to possible RF-frequencies of the sensor 106, or the coupling element 412. For example, the coupling element 412 can be tuned to an operating frequency of the sensor 106, for example, to one of the Industrial, Scientific and Medical bands (ISM) as, for example, 315 MHz, 434 MHz, etc.

In various examples, the communication interface for the communication circuitry 409 comprises an I2C or SPI commercially available for integrated circuit (IC) incorporation and use. “I2C” or “SPI” as used herein represents the inter-integrated circuit (I2C) developed by Philips (now NXP) Semiconductor, Eindhoven, Netherlands, or serial peripheral interface (SPI) developed by Motorola, Schaumberg, Ill., respectfully. In various examples, the communication circuitry 409 of the tire ID tag 224 is coupled to a power module 410, which is further coupled to the tag coupling element 412 of the tire ID tag 224. The power module 410 is configured to power the tire ID tag 224 by receiving energy through the sensor coupling element 421 from the sensor 106. That is to say the tire ID tag 224 comprises a contact to the coupling element 412 or it may comprise an on-chip coil inductively coupled to the coupling element 412.

In various examples, the sensor 106 is configured to detect certain real-time parameters of the tire 103, such as tire pressure and tire temperature. In various examples, the sensor 106 can comprise at least one of a pressure sensor to sense the inflation pressure within a cavity of the tire, a temperature sensor to measure a temperature of the tire, an accelerometer for measuring acceleration of a wheel on which the tire 103 is mounted, a revolution counter to measure a revolution time of the wheel, and/or other types of sensors.

In various examples, the sensor 106 comprises a processor, sensor communication circuitry 424, memory 428, a sensor coupling element 421, and/or other components. The sensor communication circuitry 424 can comprise a transmitter, receiver, transceiver, and/or other type of communication component that allows the sensor to communicate with the tire ID tag 224 and/or other devices. For example, the sensor communication circuitry 424 can comprise an antenna for wirelessly transmitting measured parameters and tire information data to a remote processor for analysis, such as a processor integrated into a vehicle computing device, a Controller Area Network (CAN) bus associated with the vehicle 100, and/or a cloud computing device. The sensor memory 428 stores tire ID data 415, sensor data 418, and/or other data that is specific to a given tire 103.

The sensor coupling element 421 (e.g., an antenna, a coil, etc.) is configured to provide power (e.g., RF power) to the tire ID tag 224 to enable provision of tire ID data 415. For example, the sensor 106 can comprise a dedicated output to provide power to the tire ID tag 224, where the sensor coupling element 421 can also be dedicated or used for multiple purposes among which is the provision of the power to the tire ID tag 224. In some examples, the communication circuitry 424 of the sensor 106 can be coupled to the sensor coupling element 421 (e.g., the same or another antenna or coil) and which is configured to transmit information related to a tire pressure to a receiver device of a vehicle 100, the tire ID tag 224, and/or other device.

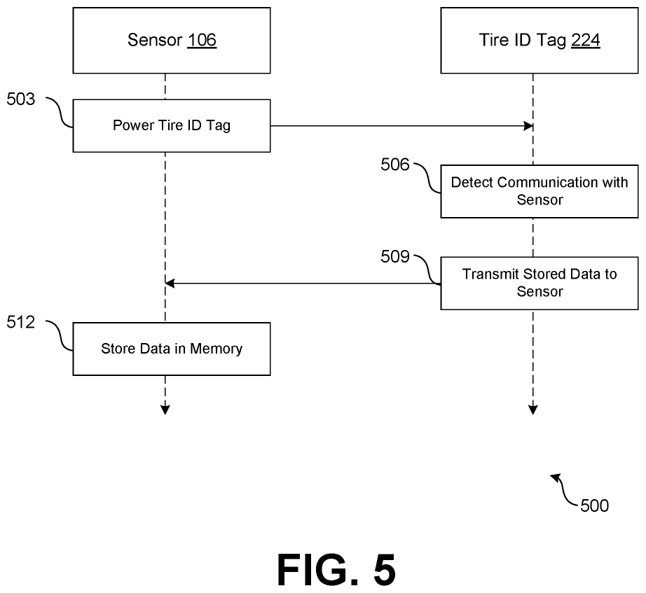

Moving on to FIG. 5, shown is an example sequence diagram 500 that provides an example of the operation of the components of the network environment 400. It is understood that the sequence diagram 500 of FIG. 5 provides merely an example of the many different types of functional arrangements that can be employed to implement the operation of the depicted portion of the network environment 400. As an alternative, the sequence diagram 500 of FIG. 5 can be viewed as depicting an example of elements of a method implemented within the network environment 400. In particular, the sequence diagram 500 of FIG. 5 depicts the functionality associated with the establishment and exchange of information between a sensor 106 and a tire identification tag 224. For example, the tire identification tag 224 includes tire ID data 415 stored in a memory 406. When a sensor 106 (e.g., original or replacement) is attached to the tire integrated mount 221 of a tire 103, the sensor 106 can power the tire identification tag 224 that is contained within or coupled to the tire integrated mount 221 and receive tire ID data 415, sensor data 418, and/or other data that is stored on the tire ID tag 224 from the tire ID tag 224.

Beginning with box 503, the sensor 106 provides power to the tire ID tag 224. For example, when the sensor 106 is supported by the tire integrated tire mount 221 of the tire, the sensor coupling element 421 (e.g., an antenna, a coil, etc.) of the sensor 106 provides power (e.g., RF power) to the tire ID tag 224 to enable provision of tire ID data 415. For example, the sensor 106 can comprise a dedicated output to provide power to the tire ID tag 224, where the sensor coupling element 421 can also be dedicated or used for multiple purposes among which is the provision of the power to the tire ID tag 224.

At box 506, the tire ID tag 224 detects the communication with the sensor 106. For example, the coupling element 412 of the tire ID tag 224 can be coupled to the sensor coupling element 421 upon placement of the sensor 106 in operational proximity to the tire ID tag 224. Accordingly, the tag coupling element 412 can receive energy (e.g., power) from the sensor coupling element 421. As such, the power module 410 of the tire ID tag 224 that is coupled to the sensor coupling element 421 can power the tire ID tag 224 using the energy received from the sensor coupling element 421, thereby detecting the sensor 106.

At box 509, the tire ID tag 224 transmits the tire ID data 415, sensor data 418, and/or other data stored in the tag memory 406 to the sensor memory 428. In various examples, the communication circuitry 409 of the tire ID tag 224 is configured to transmit the data in the tag memory 406 to communication circuitry 424 of the sensor 106.

At box 512, the sensor 106 stores the received data in the sensor memory 428. In various examples, as the sensor 106 collects parameter data associated with the tire and transmits the parameter data to a remote device, the sensor 106 can associate the collected data using the tire ID data 415 obtained from the tire ID tag 224. Thereafter, this portion of the process proceeds to completion.

In the present disclosure, disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. An apparatus, comprising:
a tire;
a sensor configured to measure one or more tire parameters of the tire;
a sensor mount integrated within the tire and being configured to support the sensor, the sensor being detachably attached to the sensor mount; and
an identification tag affixed to an inner wall of the sensor mount and in data communication with the sensor to transmit tire identification data associated with the tire to the sensor.

2. The apparatus of claim 1, wherein the identification tag comprises a radio frequency identification (RFID) tag.

3. The apparatus of claim 1, wherein the sensor comprises a sensor coupling element configured to power the identification tag when the sensor is attached to the sensor mount.

4. The apparatus of claim 3, wherein the sensor coupling element comprises an antenna or a coil.

5. The apparatus of claim 1, wherein the tire identification data comprises at least one of a tire identifier (ID), manufacturing information for the tire, size information of the tire, manufacturing location, manufacturing date, a treadcap code that correlates to a compound identification, or a mold code that correlates to a tread structure identification.

6. The apparatus of claim 1, wherein the sensor mount is integrated within an innerliner of the tire.

7. The apparatus of claim 1, wherein the sensor comprises a replacement sensor, and the tire identification data comprises sensor data associated with a defective sensor previously attached to the sensor mount and in communication with the identification tag.

8. An apparatus, comprising:
a sensor mount affixed to a tire, the sensor mount configured to support a sensor; and
a Radio Frequency Identification (RFID) tag affixed to an inner wall of the sensor mount, the RFID tag comprising tire identification data.

9. The apparatus of claim 8, wherein the sensor mount is at least partially integrated within an inner liner of the tire.

10. The apparatus of claim 8, further comprising a sensor detachably attached to the sensor mount.

11. The apparatus of claim 10, wherein the sensor comprises a first coupling element and the RFID tag comprises a second coupling element, and the first coupling element being configured to provide power to the second coupling element based at least in part on a proximity between the first coupling element and the second coupling element.

12. The apparatus of claim 8, wherein the tire identification data comprises at least one of a tire identifier (ID), manufacturing information for the tire, size information of the tire, manufacturing location, manufacturing date, a treadcap code that correlates to a compound identification, or a mold code that correlates to a tread structure identification.

13. The apparatus of claim 8, wherein the RFID tag transmits the tire identification data to a sensor in response to the sensor being attached to the sensor mount.

14. The apparatus of claim 8, wherein the RFID tag is contained within the sensor mount.

15. A method, comprising:
initiating communication between a sensor and an identification tag affixed to a mount supporting the sensor, the identification tag comprising tire identification data of a tire; and
transmitting the tire identification data from the identification tag to the sensor.

16. The method of claim 15, further comprising storing the tire identification in a memory of the sensor.

17. The method of claim 15, wherein the sensor collects parameter data associated with the tire and associates the parameter data with the tire based at least in part on the tire identification data.

18. The method of claim 15, wherein the tire identification data comprises at least one of a tire identifier (ID), manufacturing information for the tire, size information of the tire, manufacturing location, manufacturing date, a treadcap code that correlates to a compound identification, or a mold code that correlates to a tread structure identification.

19. The method of claim 15, wherein the sensor is detachably attached to the mount, and the identification tag is contained within or affixed to the mount.

20. The method of claim 15, wherein the sensor is a replacement sensor, and further comprising transmitting, by the identification tag, sensor data associated with another sensor previously attached to the mount.
